(19) United States
(12) Patent Application Publication
(10) Pub. No.: US 2012/0311457 A1
(43) Pub. Date: Dec. 6, 2012

(54) Merging Remote and Local Interfaces for Application Integration

(75) Inventor: Liam P. O'Gorman, Castleconnell (IE)

(73) Assignee: CISCO TECHNOLOGY, INC., San Jose, CA (US)

(21) Appl. No.: 13/153,998

(22) Filed: Jun. 6, 2011

(51) Int. Cl. G06F 15/16; G06F 3/048

(52) U.S. Cl. 715/740

(57) ABSTRACT

According to one embodiment, an apparatus comprises a network interface configured to enable communications over a network, and at least one processor. The apparatus creates a remote interface within a remote environment. The remote interface includes an area for receiving a local interface created within a local environment. The local and remote interfaces are combined within the remote environment to form a merged interface with the local interface disposed within the area of the remote interface. The local interface of the local environment is controlled based on manipulations of the merged interface within the remote environment. Embodiments may further include a method and computer-readable media encoded with software for merging remote and local interfaces in substantially the same manner described above.

### TECHNICAL FIELD

The present disclosure relates to local and remote interfaces and, more specifically, to merging remote and local interfaces for execution of applications.

### BACKGROUND

In a Virtual Desktop Infrastructure (VDI) deployment, there exists a class of desktop applications that do not scale well when executed in a virtualized operating system of a data center. High definition video applications are among the most problematic of these types of applications. This is due to the necessity for a high definition stream to be downloaded by a virtual machine, decoded in the virtual CPU/GPU, and re-encoded for transmission to a client for display to an end user. Since this similarly applies to an audio stream, care must be taken for certain features (e.g., lip-sync, etc.) when re-encoding to a display protocol of the virtual desktop for transmission to the client. Although providing these types of applications on the client may alleviate some of the above issues, the end user would need to switch between the hosted virtual desktop (in the display protocol rendering client) and the native client desktop.

### BRIEF DESCRIPTION OF THE DRAWINGS

FIG. 1 is a diagrammatic illustration of an example network topology or environment for merging virtual and local interfaces according to an embodiment.

FIG. 2 is a block diagram of modules within a server system for merging virtual and local interfaces according to an embodiment.

FIG. 3 is a block diagram of modules within a client system for merging virtual and local interfaces according to an embodiment.

FIGS. 4A-4B are a procedural flowchart illustrating a manner in which virtual and local interfaces are merged for execution of an application according to an embodiment.

FIG. 4C is a diagrammatic illustration of example local and virtual interfaces to be merged according to an embodiment.

FIG. 4D is a schematic illustration of example merged local and virtual interfaces according to an embodiment.

FIG. 4E is a schematic illustration of example overlaid interfaces.

FIG. 5 is a flow diagram of a manner of merging virtual and local interfaces for execution of an application according to an embodiment.

### DESCRIPTION OF EXAMPLE EMBODIMENTS

Overview

According to one embodiment, an apparatus comprises a network interface configured to enable communications over a network, and at least one processor. The apparatus creates a remote interface within a remote environment. The remote interface includes an area for receiving a local interface created within a local environment. The local and remote interfaces are combined within the remote environment to form a merged interface with the local interface disposed within the area of the remote interface. The local interface of the local environment is controlled based on manipulations of the merged interface within the remote environment. Embodiments may further include a method and computer-readable media encoded with software for merging remote and local interfaces in substantially the same manner described above.

### EXAMPLE EMBODIMENTS

Embodiments described herein are directed to merging hosted and local interfaces (e.g., local and remote hosted desktops, etc.) provided by a server or other system and a local client system. The client or local desktop interfaces or windows may be merged into a hosted virtual desktop (HVD) interface manager. This enables consumption of rich media from a network locally on the client with a seamless user experience, while maintaining high scalability of the Virtual Desktop Infrastructure (VDI). In other words, the embodiments allow a Virtual Desktop Infrastructure (VDI) to offload streaming and decoding of multimedia streams to client systems, thereby vastly improving the scalability of the VDI deployment. In addition, embodiments enable information from various sources (e.g., information from a local desktop, remote desktop. and/or a remote application; audio and/or video; real-time communications or time-sensitive information (e.g., audio, video, etc.), etc.) to be presented with a seamless user experience. In these cases, the information may be categorized, and processed by the appropriate venue or application (e.g., local or remote environment or application) with integration of the remote and local interfaces.

Attempts to compensate for Virtual Desktop Infrastructure (VDI) media limitations usually involve some very specific application changes, or are limited to a specific technology. For example, FLASH content can be rendered locally on the client when employing an INTERNET EXPLORER browser to view the content. Present embodiments have much greater flexibility, and can be applied to numerous applications (e.g., plural browsers, custom media applications, etc.).

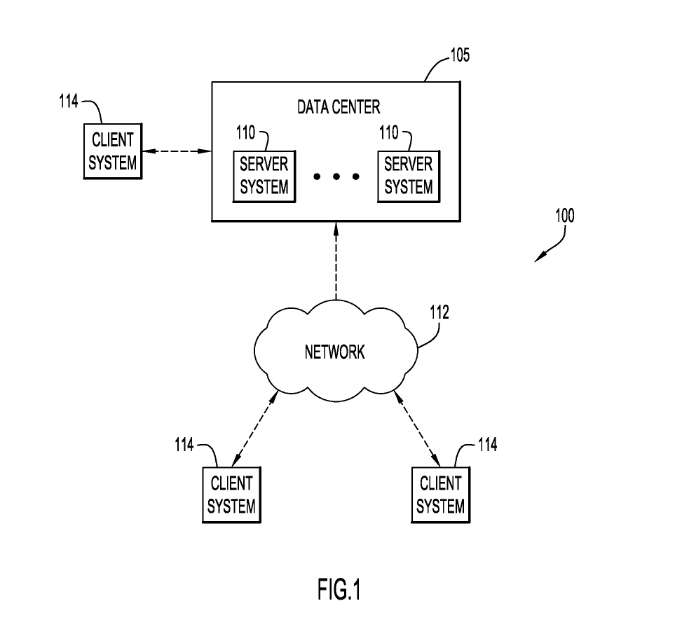

An example network topology for merging virtual and local interfaces (e.g., a hosted virtual desktop (HVD), a local desktop, etc.) according to an embodiment is illustrated in FIG. 1. Specifically, topology 100 includes a data center 105 and one or more client or end-user systems 114. Data center 105 includes one or more server systems 110 for maintaining a remote virtual environment (e.g., generating one or more hosted virtual desktops (HVD)) for client systems 114. Server systems 110 and client systems 114 may be remote from each other and communicate over a network 112. The network may be implemented by any number of any suitable communications media (e.g., wide area network (WAN), local area network (LAN), Internet, Intranet, etc.). Alternatively, server systems 110 and client systems 114 may be local to each other, and communicate via any appropriate local communication medium (e.g., local area network (LAN), hardwire, wireless link, Intranet, etc.).

Client systems 114 enable users to interact with the remote virtual environment (e.g., hosted virtual desktop (HVD), etc.) provided by server systems 110 to perform various desired actions (e.g., execute various applications, such as word processors, spreadsheet applications, browsers, etc.). The client systems are preferably implemented by “thin” client devices (e.g., possess limited applications and/or functionality), but may be implemented by client devices with any degree of functionality (e.g., may be a “thick” client device, may possess any suitable applications or degree of functionality, etc.). Server systems 110 and client systems 114 include various interface manager and other modules to facilitate merging of virtual and local interfaces between the server systems (e.g., providing the remote virtual environment) and client systems as described below. Client systems 114 may present a graphical user (e.g., GUI, desktop, etc.) or other interfaces (e.g., command line prompts, menu screens, etc.) to solicit information from users concerning desired actions (e.g., connecting to a hosted virtual desktop (HVD), invoking applications on the client system or remote virtual environment, etc.).

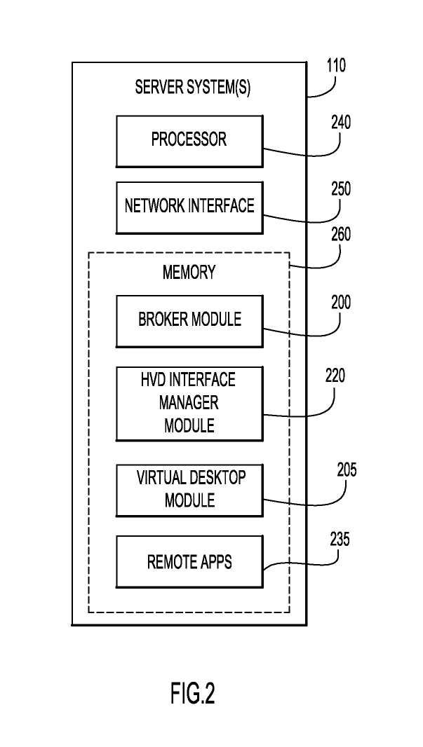

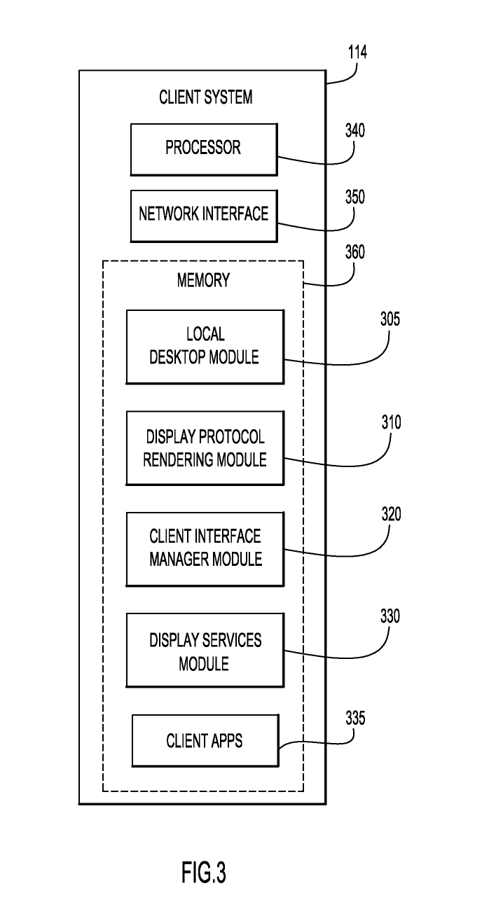

Server systems 110 may be implemented by any conventional or other computer systems preferably equipped with a display or monitor, a base (e.g., including processor 240 (FIG. 2), memories 260 and/or internal or external communications devices or network interface 250 (e.g., modem, network cards, etc.)), optional input devices (e.g., a keyboard, mouse or other input device), and any commercially available and/or custom software (e.g., server/communications software, interface manager software, etc.). Client systems 114 may be implemented by any conventional or other computer systems preferably equipped with a display or monitor, a base (e.g., including processor 340 (FIG. 3), memories 360 and/or internal or external communications devices or network interface 350 (e.g., modem, network cards, etc.)), optional input devices (e.g., a keyboard, mouse or other input device), and any commercially available and/or custom software (e.g., interface manager modules, browser/interface software, etc.). Alternatively, client systems 114 may further be implemented by any type of computer or processing device (e.g., laptop, personal digital assistant (PDA), mobile/cellular telephone devices, mobile devices (e.g., pads or tablets), etc.).

Server system 110 includes various interface manager modules to merge virtual and local interfaces (e.g., hosted virtual desktop (HVD) and local client desktop) for execution of applications as illustrated in FIG. 2. Specifically, server system 110 includes a broker module 200, a virtual desktop module 205, an HVD (hosted virtual desktop) interface manager module 220, and one or more remote applications 235. Broker module 200 provides authentication of a client system 114, locates the corresponding hosted virtual desktop (HVD) within data center 105, and redirects the client system to the hosted virtual desktop (HVD) maintained by that server system. Virtual desktop module 205 provides and maintains the hosted virtual desktop (HVD). The broker and virtual desktop modules may alternatively be implemented on separate servers or other systems within data center 105. HVD interface manager module 220 provides an interface or window frame for the hosted virtual desktop (HVD) that receives a local interface or window of the client system in order to merge the hosted virtual and local desktops as described below. Remote applications 235 include various applications (e.g., word processors, spreadsheet applications, browser, etc.) for execution on the hosted virtual desktop (HVD). The broker and virtual desktop modules are preferably implemented by corresponding modules within conventional virtual desktop implementations.

Client system 114 includes various other interface manager modules to merge a virtual interface of one or more server systems 110 (e.g., providing the virtual environment) and a local interface of client system 114 to execute applications as illustrated in FIG. 3. Specifically, client system 114 includes a local desktop module 305, a display protocol rendering module 310, a client interface manager module 320, a display services module 330, and one or more local client applications 335. Local desktop module 305 provides and maintains a local desktop. Display protocol rendering module 310 enables display on the client system of the images or screens of a hosted virtual desktop (HVD) from one or more server systems 110, and the images or screens of local desktop and/or client applications. Client interface manager module 320 provides a local interface or window for the window frame provided by the hosted virtual desktop (HVD) in order to merge the hosted virtual and local desktops as described below. Display services module 330 abstracts display hardware, and provides a mechanism (e.g., for local and virtual desktops, client applications, etc.) to create interfaces or windows. Local client applications 335 include various applications (e.g., word processors, spreadsheet applications, browser, etc.) for execution on the client system. The local desktop and display rendering protocol modules are preferably implemented by corresponding modules within conventional virtual and/or local desktop implementations.

The various modules of the server system (e.g., broker module, virtual desktop module, HVD interface manager module, etc.) and client system (e.g., local desktop module, display protocol rendering module, client interface manager module, display services module, etc.) may be implemented by any combination of any quantity of software and/or hardware modules or units, and may reside within respective memories 260, 360 of those systems for execution.

Present embodiments are preferably implemented with respect to an X-WINDOW environment. The X-WINDOW environment on a client LINUX/BSD/UNIX operating system includes various components that are combined together to produce a desktop environment. These components include an X-SERVER (e.g., display services module 330), a window manager (e.g., client interface manager module 320), and a desktop component (e.g., local desktop module 305) to provide the local desktop. The XSERVER abstracts display hardware, and provides a mechanism to create windows in a hierarchy. The XSERVER stacks or overlays the created windows, and provides mechanisms to alter the windows appropriately to provide this effect. The window manager enables various manipulations of the created windows (e.g., frame decoration (chrome), various focus interactions, resizing, dragging, moving, organizing, minimizing, maximizing, etc.). The desktop component provides shortcuts or links to invoke applications. In addition to these basic components, various extensions are available for the LINUX desktop environment. For example, an X-SHAPE extension enables non-rectangular windows to be created, while an X-VIDEO extension provides access to hardware video overlays for optimized image handling, typically required for high definition video. Present embodiments may alternatively be implemented on a WINDOWS or other client operating system by utilizing a custom interface or window manager for the desktop environment.

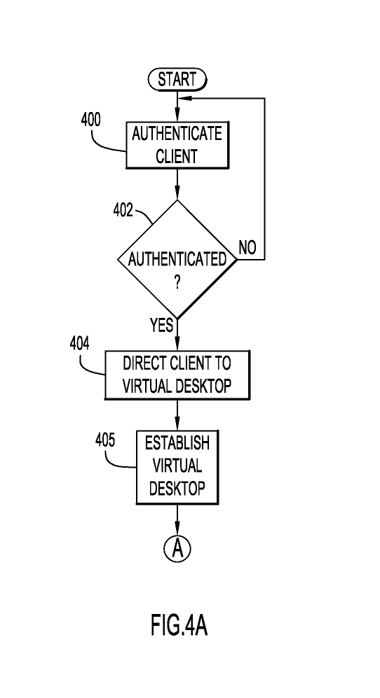

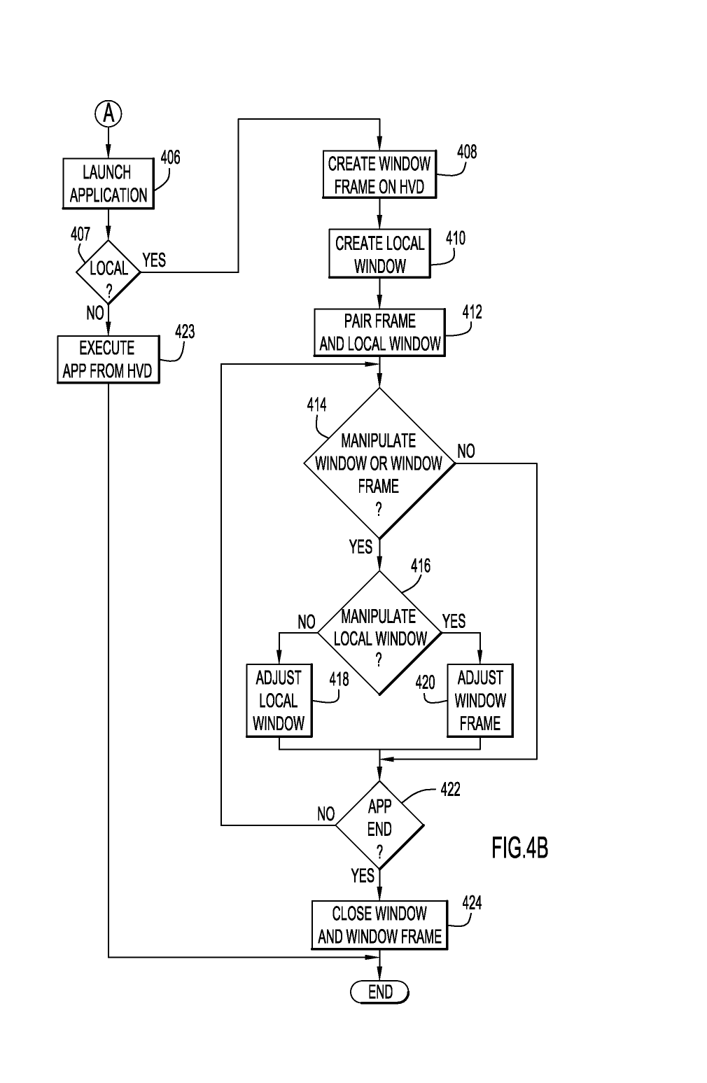

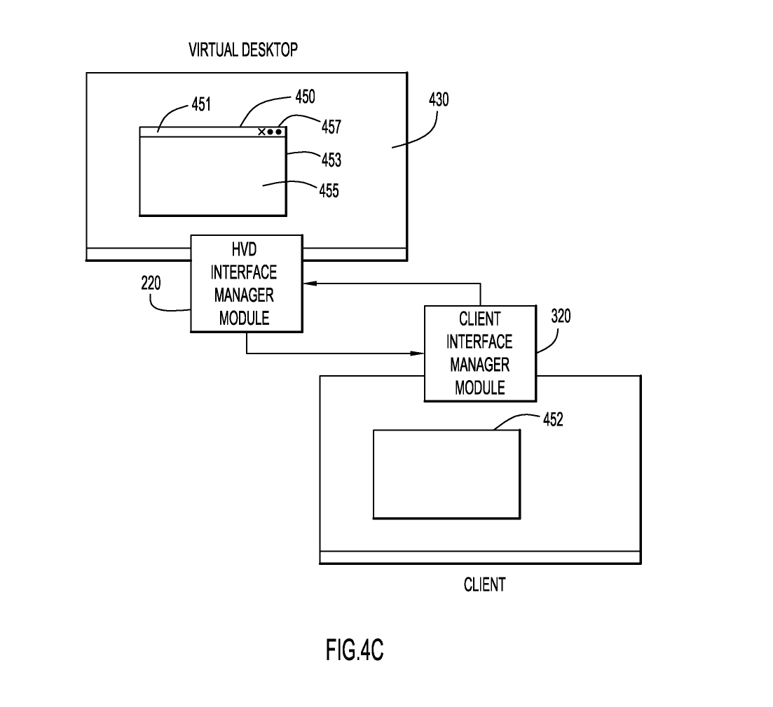

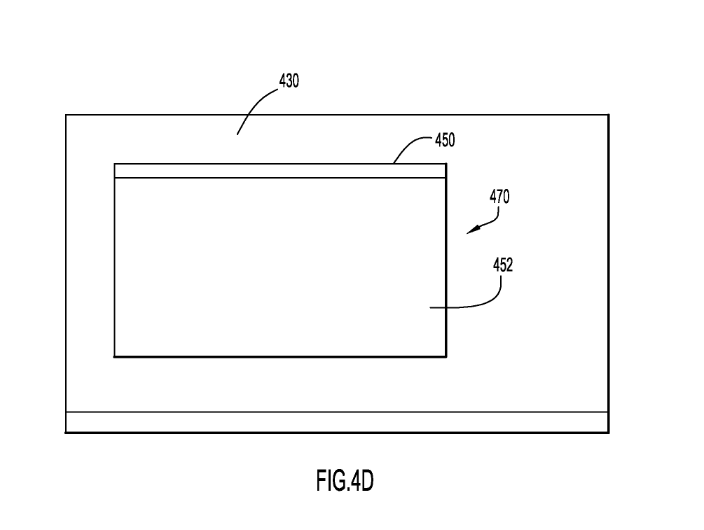

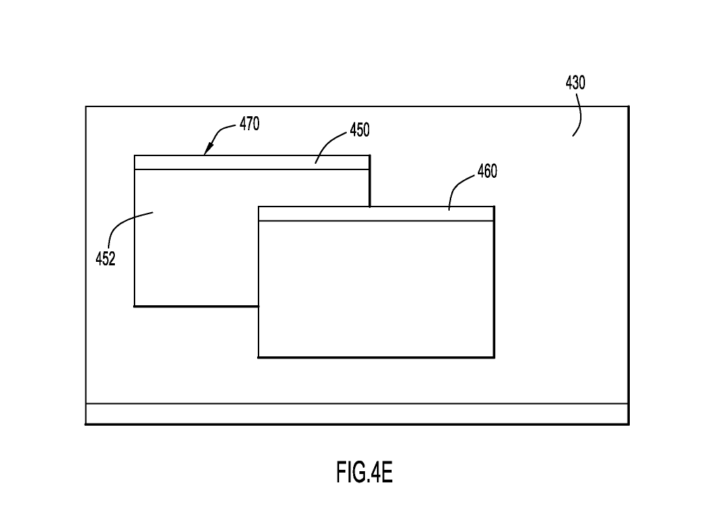

A manner in which virtual and local interfaces (e.g., respectively maintained by one or more server systems 110 and a client system 114) are merged for execution of an application is illustrated in FIGS. 4A-4E. Initially, a client system 114 is operating in a local mode (without connection to a hosted virtual desktop (HVD)). In this case, a local desktop is provided and managed by local desktop module 305 (e.g., probably in a locked down or limited mode of operation until a user is authenticated to a hosted virtual desktop (HVD)) enabling various actions (e.g., launching local applications, etc.). In order to connect to a hosted virtual desktop (HVD), client system 114 is authenticated to a server system 110 of data center 105 via broker module 200 at step 400 (FIG. 4A). This may be accomplished by any conventional or other techniques (e.g., login with user identification and password, PIN, encryption/decryption scheme, any other identifiers, etc.). Once the client system is authenticated as determined at step 402, the broker module determines the location of the corresponding hosted virtual desktop (HVD) within data center 105 (e.g., based on the information provided during the authentication), and directs the client system to that hosted virtual desktop (HVD) at step 404.

Once the client system connects to the hosted virtual desktop (HVD), a data pipe or communication channel is established between client interface manager module 320 of client system 114 and HVD interface manager module 220 (FIG. 4C) of server system 110. The hosted virtual desktop (HVD) is established and displayed on the client system at step 405. In particular, the local desktop initially displayed by client system 114 is replaced with a hosted virtual desktop (HVD) interface or window 430 (FIGS. 4C-4E) initiated by virtual desktop module 205 and displayed at client system 114 via display protocol rendering module 310 and display services module 330 of client system 114. Hosted virtual desktop (HVD) window 430 basically displays the hosted virtual desktop (HVD) (e.g., application or other icons, task bars, etc.).

When one or more local interfaces or windows exist on client system 114 (e.g., one or more local applications are executing on the client system, etc.), client interface manager module 320 creates a child interface or window of hosted virtual desktop (HVD) window 430, and designates the child window as a parent of the existing local windows. The client interface manager module further sends the locations for each of the local windows (e.g., coordinates within the display space) to HVD interface manager module 220 of server system 110. The HVD interface manager module creates an interface or window frame 450 on the hosted virtual desktop (HVD) that encompasses the local windows, while client manager module 320 sends local window identifiers (e.g., including identifiers of applications associated with the local windows and unique handles identifying the local interfaces or windows) to HVD interface manager module 220. The HVD interface manager module utilizes this information to assign icons for the existing local windows, and to associate the window frame with those local windows. This enables one or more control messages for the respective local windows and window frame to be distinguished.

In addition, client interface manager module 320 sends a list of local applications (e.g., a local web browser, media, or other client application, etc.) installed and available on the client system to HVD interface manager module 220. This information may further include icon images, application names, and supported MIME types. HVD interface manager module 220 creates shortcuts or links on the hosted virtual desktop (HVD) (e.g., on the interface screen, within program or other menus, etc.) to initiate the local applications within the received list or information.

Once the hosted virtual desktop (HVD) is established and displayed on client system 114, an end user may launch applications from within the hosted virtual desktop (HVD) environment at step 406 (FIG. 4B). The applications may be executed either remotely on the hosted virtual desktop (HVD) or server system 110, or locally on client system 114. This may be accomplished in various manners. For example, HVD interface manager module 220 may determine the venue for execution of an application (e.g., initiating a remote application on the hosted virtual desktop, initiate a local application on the client system, etc.) based on content or other criteria (e.g., media or other content, MIME types, entries in a registry, etc.). By way of example, media content may automatically be handled by a local client application in order to enhance efficiency. The HVD interface manager module may further prompt a user for a venue for execution of an application (e.g., a remote application on the hosted virtual desktop (HVD), a local application on the client system, etc.) based on the presence of certain content or criteria (e.g., media or other content, MIME types, entries in a registry, etc.). In this case, a remote application of the hosted virtual desktop (HVD) on server system 110 or a local client application on client system 114 is initiated based on the user input.

In addition, the application list provided by client interface manager module 320 may be utilized to control the venue for executing applications. For example, the list may include information for applications to be executed on the client system. In this case, the hosted virtual desktop (HVD) is updated with links that cause the applications to be executed locally on the client system as described above, while remaining applications are executed on the hosted virtual desktop (HVD) in a normal manner.

When a remote application is initiated from the hosted virtual desktop (HVD) as determined at step 407, the remote application is simply executed on the hosted virtual desktop (HVD) in a corresponding window generated by HVD interface manager module 220 at step 423.

However, a client application may be initiated from the hosted virtual desktop (HVD) as determined at step 407. This may be accomplished via a corresponding shortcut or link on the hosted virtual desktop (HVD) to the client application, or via the techniques described above. In this case, HVD interface manager module 220 sends one or more messages to the client system to launch the client application, and creates hosted virtual desktop (HVD) interface or window frame 450 (FIG. 4C) at step 408. Window frame 450 includes a title bar 451, a frame 453, and a client area 455. Title bar 451 is disposed within an upper portion of window frame 450, and includes a title for the window frame and a series of actuators 457 for window frame manipulations (e.g., maximize, minimize, close, etc.). Frame 453 represents the structure of window frame 450, and may be adjusted in various manners (e.g., adjustable size, adjustable location, etc.). Client area 455 is disposed within the interior of frame 453, and receives a local interface or window 452 (e.g., generated by the client application via display protocol rendering module 310 and display services module 330) as described below. Client interface manager module 320 creates a local interface or window for the client application at step 410, and determines a local window identifier (e.g., including an identifier of the application associated with the local window and a unique handle identifying the local interface or window). The local window identifier is sent to HVD interface manager module 220 to associate the local window with the window frame at step 412.

A merged window 470 (e.g., FIG. 4D) including window frame 450 and corresponding local window 452 disposed within client area 455 (e.g., for displaying content for the launched client application) is displayed on client system 114 (e.g., via display protocol rendering module 310 and display services module 330). A user may interact with or manipulate (e.g., move, re-size, minimize, maximize, overlaid windows, etc.) the merged window (e.g., window frame 450 and/or local window 452) in the hosted virtual desktop (HVD) as determined at step 414. If window frame 450 is adjusted as determined at step 416, HVD interface manager module 220 tracks changes to the window frame, and sends one or more messages including the local window identifier of the corresponding local window (e.g., including the identifier of the application associated with the local window and the unique window handle) and information pertaining to the window frame changes to client interface manager module 320 on client system 114. The client interface manager module identifies the corresponding local window based on the received local window identifier, and applies changes to the corresponding local window at step 418 in accordance with the information indicated within the received messages.

For example, the changes to window frame 450 may include adjusting the size of the window frame (e.g., including a maximization of the window frame to full screen). In this case, HVD interface manager module 220 monitors user manipulation of the window frame geometry, and adjusts window frame 450 accordingly. The HVD interface manager module further sends one or more messages including the local window identifier of the corresponding local window (e.g., including the identifier of the application associated with the local window and the unique window handle) and sizing information (e.g., dimensions, etc.) pertaining to the adjusted size of the window frame to client interface manager module 320 on client system 114. The client interface manager module identifies the corresponding local window based on the received local window identifier, determines the appropriate size for local window 452 based on the sizing information within the received messages, and adjusts the size of the corresponding local window for consistency with the adjusted size of window frame 450. The modified merged window including window frame 450 and corresponding local window 452 is displayed on client system 114 (e.g., via display protocol rendering module 310 and display services module 330).

Further, the location of the window frame within the hosted virtual desktop (HVD) may be adjusted based on user manipulation. In this case, HVD interface manager module 220 monitors window frame 450, and adjusts the location of the window frame within the hosted virtual desktop (HVD) in accordance with user manipulation of the window frame location. The HVD interface manager module further sends one or more messages including the local window identifier of the corresponding local window (e.g., including the identifier of the application associated with the local window and the unique window handle) and location information (e.g., coordinates within the display space, etc.) pertaining to the adjusted location of window frame 450 to client interface manager module 320 on client system 114. The client interface manager module identifies the corresponding local window based on the received local window identifier, and adjusts the location of the local window in accordance with the location information within the received messages for consistency with window frame 450. The modified merged window including window frame 450 and corresponding local window 452 is displayed on client system 114 (e.g., via display protocol rendering module 310 and display services module 330).

With respect to minimizing window frame 450, the window frame and corresponding local window are hidden on the hosted virtual desktop (HVD). In this case, HVD interface manager module 220 monitors window frame 450, and hides the window frame on the hosted virtual desktop (HVD) in accordance with user actuation of a window frame actuator 457 for minimization. The HVD interface manager module further sends one or more messages to client interface manager module 320 on client system 114 including the local window identifier of the corresponding local window (e.g., including the identifier of the application associated with the local window and the unique window handle) and indicating the minimization. The client interface manager module identifies the corresponding local window based on the received local window identifier, and basically re-sizes the corresponding local window to an appropriate size that effectively hides the local window on the hosted virtual desktop (HVD). The modified hosted virtual desktop (HVD) is displayed on client system 114 (e.g., via display protocol rendering module 310 and display services module 330).

In order to restore minimized merged window 470, window frame 450 is restored by HVD interface manager module 220, while the size of the corresponding minimized local window is adjusted or re-sized in substantially the same manner described above based on the restoration size of the window frame.

Similarly, if the local window is manipulated (e.g., by the local application or a user) as determined at step 416, client interface manager module 320 tracks changes to the local window geometry, and sends the changes to HVD interface manager module 220 on server system 110. The HVD interface manager module applies the changes to window frame 450 at step 420 for consistency with the modified local window.

For example, the changes may include adjusting the size of the local window. In this case, client interface manager module 320 monitors the local window geometry, and may selectively perform the re-sizing based on any suitable criteria (e.g., parameter setting, conditions preventing or enabling the window re-sizing, etc.). When the client interface manager module determines to perform the re-sizing of the local window, the local window is re-sized and one or more messages including the local window identifier of the corresponding local window (e.g., including the identifier of the application associated with the local window and the unique window handle) and sizing information (e.g., dimensions, etc.) pertaining to the adjusted size of the local window are sent to HVD interface manager module 220 on server system 110. The HVD interface manager module identifies the corresponding window frame based on the received local window identifier, determines the appropriate size for window frame 450 based on the sizing information within the received messages, and adjusts the size of the corresponding window frame for consistency with the adjusted size of the corresponding local window. The modified merged window including window frame 450 and corresponding local window 452 is displayed on client system 114 (e.g., via display protocol rendering module 310 and display services module 330).

In the event of a maximization of the local window (e.g., to full screen), client interface manager module 320 enables enlargement of the local window. Since a window frame 450 is not displayed in this case, no communication is sent to HVD interface manager module 220.

Further, location of the local window may be adjusted. In this case, client interface manager module 320 monitors the local window, and adjusts the location of the local window accordingly. The client interface manager module further sends one or more messages including the local window identifier of the corresponding local window (e.g., including the identifier of the application associated with the local window and the unique window handle) and location information (e.g., coordinates within the display space, etc.) pertaining to the adjusted location of the local window to HVD interface manager module 220 on server system 110. The HVD interface manager module identifies the corresponding window frame based on the received local window identifier, and adjusts the location of the corresponding window frame for consistency with the adjusted location of the local window. The modified merged window including window frame 450 and corresponding local window 452 is displayed on client system 114 (e.g., via display protocol rendering module 310 and display services module 330).

With respect to minimizing the local window, the window frame and local window are hidden on the hosted virtual desktop (HVD). In this case, client interface manager module 320 monitors the local window, and re-sizes the local window to an appropriate size that effectively hides the local window on the hosted virtual desktop (HVD) as described above. The client interface manager module further sends one or more messages including the local window identifier of the corresponding local window (e.g., including the identifier of the application associated with the local window and the unique window handle) and indicating the minimization to HVD interface manager module 220 on server system 110. The HVD interface manager module identifies the corresponding window frame based on the received local window identifier, and hides the corresponding window frame on the hosted virtual desktop (HVD). The modified hosted virtual desktop (HVD) is displayed on client system 114 (e.g., via display protocol rendering module 310 and display services module 330). The minimized merged window may be restored in substantially the same manner described above.

In addition, regions of window frame 450 and/or local window 452 may be clipped to allow for seamless integration of an overlay pattern of windows 450, 460 (or z-order indicating the order or arrangement of the overlaid windows) (FIG. 4E). HVD interface manager module 220 detects the order of overlaid windows (e.g., z-order indicating the order or arrangement of the overlaid windows) on the hosted virtual desktop (HVD), and determines the clipping geometry for modification of window frame 450 and/or local window 452 based on the position and arrangement of the overlaid windows. HVD interface manager module 220 may utilize various techniques (e.g., chroma-key type image edge detection, etc.) in order to efficiently track the appropriate clipping geometry. HVD interface manager module 220 adjusts window frame 450 in accordance with the determined clipping geometry, and sends one or more messages including the local window identifier of the corresponding local window (e.g., including the identifier of the application associated with the local window and the unique window handle) and clipping information pertaining to the determined clipping geometry to client interface manager module 320. The client interface manager module identifies the corresponding local window based on the received local window unique identifier, and adjusts the geometry of the corresponding local window in accordance with the clipping geometry information within the received messages to accommodate overlaid windows 450, 460, and provide the appropriate portion of the corresponding local window. The modified windows are displayed on client system 114 (FIG. 4E) (e.g., via display protocol rendering module 310 and display services module 330).

As the user traverses between local and remote interfaces on the hosted virtual desktop (HVD), one or more messages (e.g., WINDOWS FOCUS messages, etc.) are exchanged between client interface manager module 320 and HVD interface manager module 220 to perform the operations described above and maintain the single window environment experience. This enables the end user to control the local windows from within the hosted virtual desktop (HVD) environment without having to change to the local client window environment. Once termination of the client application is requested at step 422, the local window and window frame are closed at step 424, and the application terminates.

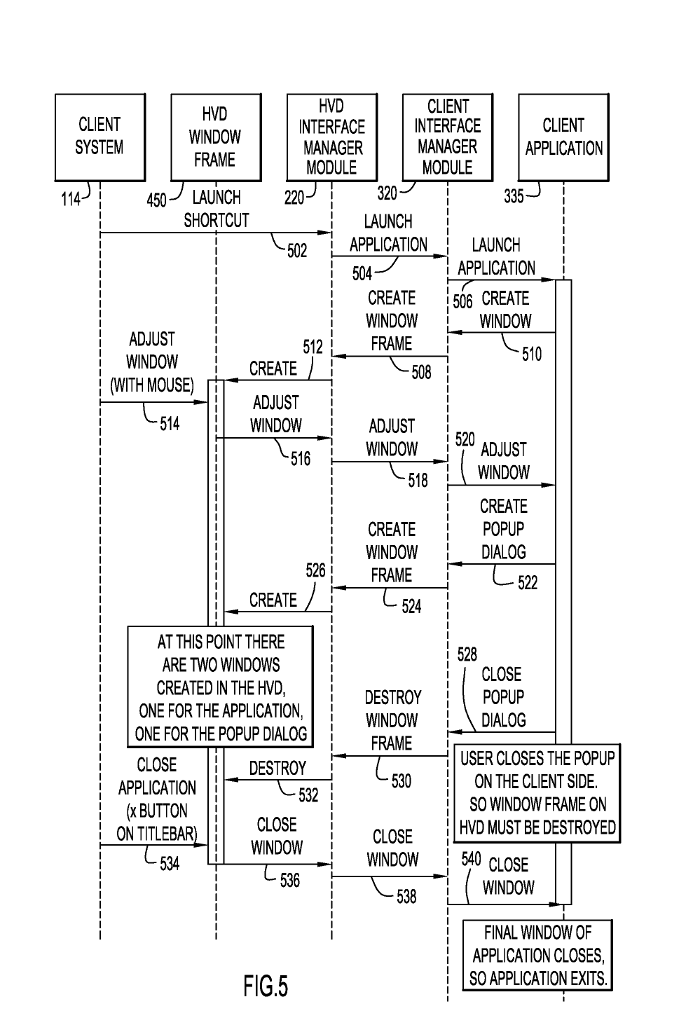

Operation of an embodiment merging virtual and local interfaces (e.g., respectively maintained by one or more server systems 110 and a client system 114) for execution of a client application is illustrated, by way of example, in FIG. 5. Initially, a local client application 335 is initiated from a hosted virtual desktop (HVD) on client system 114 at flow 502. This may be accomplished via a corresponding shortcut or link on the hosted virtual desktop (HVD) to the local client application, or via the techniques described above. HVD interface manager module 220 detects the application initiation, and informs client system 114 of the initiation at flow 504 to invoke client application 335 at flow 506. The HVD interface manager module further generates a corresponding window frame 450 (e.g., FIGS. 4C-4D) at flow 508.

A local window 452 (e.g., FIGS. 4C-4D) for the initiated local client application is created by client interface manager module 320 at flow 510. The client interface manager module further communicates with HVD interface manager module 220 of server system 110 to provide the local window identifier for association of the local window with window frame 450. The window frame and local window 452 for the initiated local client application are combined to form a merged window 470 at flow 512 as described above (e.g., FIG. 4D).

A user may interact with or manipulate merged window 470 in the hosted virtual desktop (HVD) (e.g., move, re-size, minimize, maximize, overlaid windows, etc.) as described above. By way of example, window frame 450 of merged window 470 may be adjusted (e.g., moved, re-sized, minimized, maximized, overlaid windows, etc.) at flow 514. In this case, HVD interface manager module 220 monitors window frame 450, and adjusts the window frame accordingly at flow 516. The HVD window manger further sends information pertaining to the adjustment (e.g., sizing information, location information, clipping geometry, etc.) to client interface manager module 320 on client system 114 at flow 518. The client window module adjusts the local window in accordance with the received information pertaining to the adjustment of window frame 450 at flow 520.

Client application 335 may provide a dialog box in response to user actions. Client interface manager module 320 generates a local window for the dialog box at flow 522. The client interface manager module further communicates with HVD interface manager module 220 of server system 110 to generate a corresponding window frame for the local window at flow 524. The window frame contains the local window with the dialog box at flow 526. At this point, merged windows (e.g., window frame 450 and corresponding local window 452) are created for each of the dialog box and local client application 335. Regions of these merged windows (e.g., window frame 450 and/or local window 452) may be clipped to allow for seamless integration in the event the merged windows are overlaid as described above.

Once interaction with the dialog box is completed by a user, the dialog box is closed at flow 528 by client interface manager module 320. The client interface manager module further communicates with HVD interface manager module 220 of server system 110 to close the corresponding window frame at flow 530. Accordingly, the merged window for the dialog box is removed from the display at flow 532.

When termination of the client application is requested (e.g., local client application is closed by the user) at flow 534, HVD interface manager module 220 detects the requested termination and closes the corresponding window frame at flow 536. The HVD interface manager module communicates with client interface manager module 320 to close the local window for the application at flow 538. Once the window frame and local window are closed, the local client application exits at flow 540.

It will be appreciated that the embodiments described above and illustrated in the drawings represent only a few of the many ways of implementing embodiments for merging remote and local interfaces for application integration.

The topology or environment of the present embodiments may include any number of computer or other processing systems (e.g., client or end-user systems, server systems, etc.) arranged in any desired fashion, where these embodiments may be applied to any desired type of computing environment (e.g., cloud computing, client-server, network computing, etc.). The computer or other processing systems (e.g., client systems, server systems, etc.) employed by these embodiments may be implemented by any number of any personal or other type of computer or processing system (e.g., IBM-compatible, APPLE, laptop, tablets, etc.), and may include any commercially available operating system and any commercially available or custom software (e.g., browser software, communications software, server software, interface manager modules, etc.). These systems may include any types of monitors and input devices (e.g., keyboard, mouse, voice recognition, touch screen, etc.) to enter and/or view information. In addition, the client systems may be implemented by any personal or other type of computer or processing device (e.g., laptop, notebook, personal or other computer system, personal digital assistant (PDA), mobile/cellular telephones, mobile computing devices (e.g., pads, tablets, etc.)).

It is to be understood that the software (e.g., interface manager modules including the broker module, virtual desktop module, HVD interface manager module, local desktop module, display protocol rendering module, client interface manager module, display services module, etc.) of the present embodiments may be implemented in any desired computer language and could be developed by one of ordinary skill in the computer arts based on the functional descriptions contained in the specification and flow charts and/or diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts and/or diagrams may be modified in any manner that accomplishes the functions described herein. In addition, the functions in the flow charts and/or diagrams or description may be performed in any order that accomplishes a desired operation.

The software of the present embodiments (e.g., interface manager modules including the broker module, virtual desktop module, HVD interface manager module, local desktop module, display protocol rendering module, client interface manager module, display services module, etc.) may be made available as a program product apparatus or device including a recordable or computer usable or readable medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

Further, the memories of the computer systems or devices of present embodiments may comprise read only memory (ROM), random access memory (RAM), magnetic disk storage media devices, optical storage media devices, flash memory devices, electrical, optical, or other physical/tangible memory storage devices. Thus, in general, the memory may comprise one or more computer readable storage media (e.g., a memory device) encoded with software or logic comprising computer executable instructions and, when executed (by the corresponding processor of the computer system or device), the software is operable to perform the operations described herein.

The communication network may be implemented by any number of any type of communications network (e.g., LAN, WAN, Internet, Intranet, VPN, etc.). The computer or other processing systems of these embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

These embodiments may employ any number of any conventional or other databases, data stores or storage structures (e.g., files, databases, data structures, data or other repositories, etc.) to store information. A database system may be included within or coupled to the server and/or client systems. The database system and/or storage structure may be remote from or local to the computer or other processing systems, and may store any desired data.

The embodiments may distribute any quantity of any types of applications or other procedural instructions or content (e.g., computer programs, routines, macros, libraries, scripts, patches, audio, video, etc.) between a remote environment and a client system. Further, present embodiments may distribute any quantity of components of any types of applications or other procedural instructions or content (e.g., computer programs, routines, macros, libraries, scripts, patches, multimedia streams, audio, video, etc.) between a remote environment and a client system. The remote environment may include any type of environment providing a local or remote service or task (e.g., one or more remote or virtual applications, a remote or virtual desktop, a remote or virtual machine, a virtual tablet, a virtual gaming console, a web application, etc.), while the applications may include any type of application (e.g., word processing, media, browser, communication, etc.). The distribution of applications or content may be pre-configured or determined dynamically based on any desired criteria (e.g., user input, content type, etc.). The embodiments may be utilized to distribute any applications or other procedural instructions or content across, and/or merge interfaces from, any computing systems, devices, and/or operating systems.

The interface manager modules may be in the form of application plugins (e.g., for applications on the client and server systems), stand-alone modules, or embedded within other modules (e.g., embedded within a browser, operating system, etc.).

The local interface or window may be of any quantity, size, or shape, and may contain information from any desired source (e.g., network, local application, etc.). The local window may be adjusted in any desired fashion (e.g., moved, re-sized, minimized, maximized, overlaid windows, etc.) based on any requests (e.g., user input or manipulation, local or remote applications, etc.). The interface or window frame may be of any quantity, size, or shape, include any one or more portions of an interface or window to form a template, and may contain information from any desired source (e.g., network, local application, local window, etc.). The window frame may be adjusted in any desired fashion (e.g., moved, re-sized, minimized, maximized, overlaid windows, etc.) based on any requests (e.g., user input or manipulation, local or remote applications, etc.). Any quantity of local windows may be associated with a window frame, while any quantity of window frames may be associated with a local window (e.g., for display of plural frames).

The adjustments of the local window and window frame may be tracked via any conventional or other techniques, and may be communicated between the remote and local environments in any desired fashion to maintain consistency between the local windows and window frame. The messages may be of any format, and include any desired information pertaining to identification of the local windows and/or adjustments. The corresponding adjustments to a local window based on modification of the window frame may be determined remotely and transmitted to the client system for modification of the client window. Alternatively, the adjustments to the local window may be determined locally based on received information pertaining to adjustments made to the window frame. Similarly, the corresponding adjustments to a window frame based on modification of the local window may be determined remote from the window frame (on the client system) and transmitted to the server system for modification of the window frame. Alternatively, the adjustments to the window frame may be determined locally (on the server system) based on received information pertaining to adjustments made to the local window.

The local windows and window frame may be associated in any desired fashion based on any suitable identifiers (e.g., interface identifiers, application identifiers, machine identifiers, addresses, combinations thereof, etc.). The identifiers may be of any length, and include any suitable numeric and/or alphanumeric characters and/or symbols.

Present embodiments may be further applied to merge or synchronize any suitable interfaces, information, and/or processes or applications between local and remote (or virtual) environments on the same or different computer systems (e.g., bookmarks, cookies, security identity between processes on different machines, etc.). For example, real-time audio and video information may be categorized, and processed by one or more corresponding local applications, where the window frame and one or more local interfaces for the corresponding applications may be integrated in substantially the same manner described above for a seamless user experience. Further, information from various sources (e.g., remote desktop, remote application, local environment, audio, video, etc.) may similarly be processed within the appropriate venue, where interfaces for these venues may be integrated in substantially the same manner described above to provide a seamless user experience.

Although present embodiments have been described, by way of example only, with respect to hosted virtual desktops (HVD), the present embodiments may be utilized with any types of hosted desktops or environments (e.g., local desktops or environments, hosted desktops on other physical remote or local machines, hosted desktops on local or remote shared machines, etc.).

It will be understood that the terms “comprises”, “comprising”, “includes”, “including”, “has”, “have”, “having”, “with” and the like, when used in this specification and the claims, specify the presence of stated features, but do not preclude the presence or addition of one or more other features.

From the foregoing description, it will be appreciated that the techniques disclosed herein make available novel embodiments for merging remote and local interfaces for application integration, wherein remote and local interfaces are merged for execution of applications.

Having described example embodiments of a new and improved technique for merging remote and local interfaces for application integration, it is believed that other modifications, variations and changes will be suggested to those skilled in the art in view of the teachings set forth herein. It is therefore to be understood that all such variations, modifications and changes are believed to fall within the scope defined by the appended claims.

What is claimed is:

1. A method comprising:
generating a local interface within a local environment;
creating a remote interface within a remote environment, wherein said remote interface includes an area for receiving said local interface, and wherein said local environment and said remote environment are provided by one or more computing devices;
combining said local and remote interfaces within said remote environment to form a merged interface with said local interface disposed within said area of said remote interface; and
controlling said local interface of said local environment based on manipulations of said merged interface within said remote environment.

2. The method of claim 1, wherein said local environment includes a local desktop.

3. The method of claim 1, wherein said remote environment includes a hosted desktop.

4. The method of claim 1, wherein said local interface is associated with an application executing within said local environment.

5. The method of claim 4, wherein said application executing within said local environment is initiated from said remote environment.

6. The method of claim 5, wherein said merged interface of said remote environment enables interaction with said application executing within said local environment.

7. The method of claim 1, wherein an identifier assigned to said local interface associates said local interface with said remote interface, and said controlling said local interface includes:
detecting adjustments to said remote interface within said remote environment;
sending said identifier and information concerning said adjustments to said local environment; and
identifying said local interface based on said identifier and modifying said identified local interface within said local environment in accordance with said adjustment information for consistency with said adjusted remote interface.

8. The method of claim 7, wherein said adjustments to said remote interface include one of moving said remote interface, re-sizing said remote interface, minimizing said remote interface, maximizing said remote interface, and overlaying said remote interface and another interface within said remote environment.

9. An apparatus comprising:
a network interface configured to enable communications over a network; and
at least one processor configured to:
create a remote interface within a remote environment, wherein said remote interface includes an area for receiving a local interface created within a local environment;
combine said local and remote interfaces within said remote environment to form a merged interface with said local interface disposed within said area of said remote interface; and
control said local interface of said local environment based on manipulations of said merged interface within said remote environment.

10. The apparatus of claim 9, wherein said local environment includes a local desktop.

11. The apparatus of claim 9, wherein said remote environment includes a hosted desktop.

12. The apparatus of claim 9, wherein said local interface is associated with an application executing within said local environment.

13. The apparatus of claim 12, wherein said at least one processor is further configured to:
initiate execution of said application within said local environment from said remote environment.

14. The apparatus of claim 12, wherein said at least one processor is further configured to:
interact with said application executing within said local environment via said merged interface of said remote environment.

15. The apparatus of claim 9, wherein an identifier assigned to said local interface associates said local interface with said remote interface, and said controlling said local interface includes:
detecting adjustments to said remote interface within said remote environment; and
sending said identifier and information concerning said adjustments to said local environment to identify said local interface and modify said identified local interface within said local environment in accordance with said adjustment information for consistency with said adjusted remote interface.

16. The apparatus of claim 15, wherein said adjustments to said remote interface include one of moving said remote interface, re-sizing said remote interface, minimizing said remote interface, maximizing said remote interface, and overlaying said remote interface and another interface within said remote environment.

17. One or more computer-readable storage media encoded with software comprising computer executable instructions and when the software is executed operable to:
generate a local interface within a local environment;
create a remote interface within a remote environment, wherein said remote interface includes an area for receiving said local interface, and wherein said local environment and said remote environment are provided by one or more computing devices;
combine said local and remote interfaces within said remote environment to form a merged interface with said local interface disposed within said area of said remote interface; and
control said local interface of said local environment based on manipulations of said merged interface within said remote environment.

18. The computer-readable media of claim 17, wherein said local environment includes a local desktop.

19. The computer-readable media of claim 17, wherein said remote environment includes a hosted desktop.

20. The computer-readable media of claim 17, wherein said local interface is associated with an application executing within said local environment.

21. The computer-readable media of claim 20, wherein said software further includes software to:
initiate execution of said application within said local environment from said remote environment.

22. The computer-readable media of claim 20, wherein said software further includes software to:
interact with said application executing within said local environment via said merged interface of said remote environment.

23. The computer-readable media of claim 17, wherein an identifier assigned to said local interface associates said local interface with said remote interface, and said controlling said local interface includes:
detecting adjustments to said remote interface within said remote environment;
sending said identifier and information concerning said adjustments to said local environment; and
identifying said local interface based on said identifier and modifying said identified local interface within said local environment in accordance with said adjustment information for consistency with said adjusted remote interface.

24. The computer-readable media of claim 23, wherein said adjustments to said remote interface include one of moving said remote interface, re-sizing said remote interface, minimizing said remote interface, maximizing said remote interface, and overlaying said remote interface and another interface within said remote environment.
